(19) United States
(12) Patent Application Publication
(10) Pub. No.: US 2026/0008165 A1
(43) Pub. Date: Jan. 8, 2026

(54) POWER TOOL EXTENSION POLE ASSEMBLY

(71) Applicant: MILWAUKEE ELECTRIC TOOL CORPORATION, Brookfield, WI (US)

(72) Inventors: Ivan N. Zozulya, Waukesha, WI (US); Bradley S. Houskamp, Wauwatosa, WI (US); Connor D. Sreenan, Wauwatosa, WI (US); Mitchell T. Neuhoff, Waukesha, WI (US)

(21) Appl. No.: 19/258,269

(22) Filed: Jul. 2, 2025

Related U.S. Application Data
(60) Provisional application No. 63/667,851, filed on Jul. 5, 2024.

(51) Int. Cl. B25C 7/00; B25C 1/06

(52) U.S. Cl. CPC B25C 7/00; B25C 1/06

(57) ABSTRACT

An extension pole assembly for a power tool includes a mount having a first mount portion and a second mount portion, the second mount portion configured to pivot relative to the first mount portion to at least partially enclose the power tool within the mount, an extension pole having a first extension pole end and an opposite, second extension pole end coupled to the mount, a handle coupled to the first extension pole end, the handle to be grasped by a user of the power tool, and an actuator linkage extending between the first extension pole end and the second extension pole end. The actuator linkage includes a lever pivotably coupled to the mount. The lever is pivotable from a first position towards a second position to actuate the power tool.

### CROSS-REFERENCE TO RELATED APPLICATIONS

This application claims priority to U.S. Provisional Patent Application No. 63/667,851, filed July 5, 2024, the entire content of which is incorporated herein by reference.

### FIELD OF THE INVENTION

The present invention relates to power tools, and more particularly to extension pole assemblies for supporting power tools.

### BACKGROUND OF THE INVENTION

A user may desire to operate a power tool remotely with the power tool being supported at a distance from the user. An extension pole assembly may allow the user to operate the power tool remotely.

### SUMMARY OF THE INVENTION

The present invention provides, in one aspect, an extension pole assembly for a power tool. The extension pole assembly includes a mount having a first mount portion and a second mount portion. The second mount portion pivots relative to the first mount portion to at least partially enclose the power tool within the mount. The extension pole assembly includes an extension pole having a first extension pole end and an opposite, second extension pole end coupled to the mount. The extension pole assembly includes a handle coupled to the first extension pole end. The handle may be grasped by a user of the power tool. The extension pole assembly includes an actuator linkage extending between the first extension pole end and the second extension pole end. The actuator linkage includes a shaft extending between the first extension pole end and the second extension pole end, a hook supported by the mount and having a first portion that engages a trigger of the power tool when supported within the mount, and a lever pivotably coupled to the mount and having a first lever end abutted with the shaft and a second lever end coupled to a second portion of the hook. In response to movement of the shaft within the extension pole, the lever is pivotable from a first position towards a second position, in which the first portion of the hook depresses the power tool trigger.

The present invention provides, in another aspect, a powered fastener driver assembly. The powered fastener driver assembly includes a powered fastener driver including a housing having a driver portion in which a reciprocating drive blade is movable and a handle portion extending from the driver portion. The powered fastener driver assembly includes an extension pole assembly including a mount having a first mount portion and a second mount portion. The second mount portion pivots relative to the first mount portion to at least partially enclose the powered fastener driver within the mount. The extension pole assembly includes an extension pole having a first extension pole end and an opposite, second extension pole end coupled to the mount. The extension pole assembly includes a handle coupled to the first extension pole end. The handle may be grasped by a user of the powered fastener driver. The extension pole assembly includes an actuator linkage extending between the first extension pole end and the second extension pole end. The actuator linkage includes a shaft extending between the first extension pole end and the second extension pole end, a hook supported by the mount and having a first portion that engages a trigger of the powered fastener driver when supported within the mount, and a lever pivotably coupled to the mount and having a first lever end abutted with the shaft and a second lever end coupled to a second portion of the hook. In response to movement of the shaft within the extension pole, the lever is pivotable from a first position towards a second position, in which the first portion of the hook depresses the trigger of the powered fastener driver, wherein the mount at least partially encloses the driver portion of the housing.

The present invention provides, in another aspect, an extension pole assembly for a power tool. The extension pole assembly includes a carbon fiber mount having a first mount portion and a second mount portion. The second mount portion pivots relative to the first mount portion to at least partially enclose the power tool within the mount. An extension pole has a first extension pole end and an opposite, second extension pole end coupled to the mount. A handle is coupled to the first extension pole end. The handle is to be grasped by a user of the power tool. An actuator linkage extends between the first extension pole end and the second extension pole end. The actuator linkage includes a lever pivotably coupled to the mount. The lever is pivotable from a first position towards a second position to actuate the power tool.

Other features and aspects of the invention will become apparent by consideration of the following detailed description and accompanying drawings.

### BRIEF DESCRIPTION OF THE DRAWINGS

FIG. 1 is a perspective view of a user operating a powered fastener driver and extension pole assembly, in accordance with an embodiment of the invention.

FIG. 2 is a perspective view of the extension pole assembly of FIG. l.

Fig.3 is a side view of the extension pole assembly of FIG. 1.

Fig. 4 is a cross-sectional view of the extension pole assembly of FIG. I along section line 4-4 in FIG. 1.

FIG. 5 is a bottom view of the extension pole assembly of FIG. 1. FIG. 6 is a top view of the extension pole assembly of FIG. 1. FIG. 7 is a front view of the extension pole assembly of FIG. 1. FIG. 8 is a rear view of the extension pole assembly of FIG. 1. FIG. 9 is a cross-sectional view of the extension pole assembly of FIG. 1 along section line 9-9 in FIG. 6.

FIG. 10 is a rear perspective cutaway view of a portion of an actuator linkage of the extension pole assembly of FIG. 1 with a trigger of the attached power tool schematically illustrated.

FIG. 11 is a rear perspective cutaway view of the portion of the actuator linkage of FIG. 10 with the power tool trigger removed. FIG. 12 is a front perspective cutaway view of the portion of the actuator linkage of FIG. 10 with the power tool trigger removed. FIG. 13 is a side view of an extension pole and handle of the extension pole assembly of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

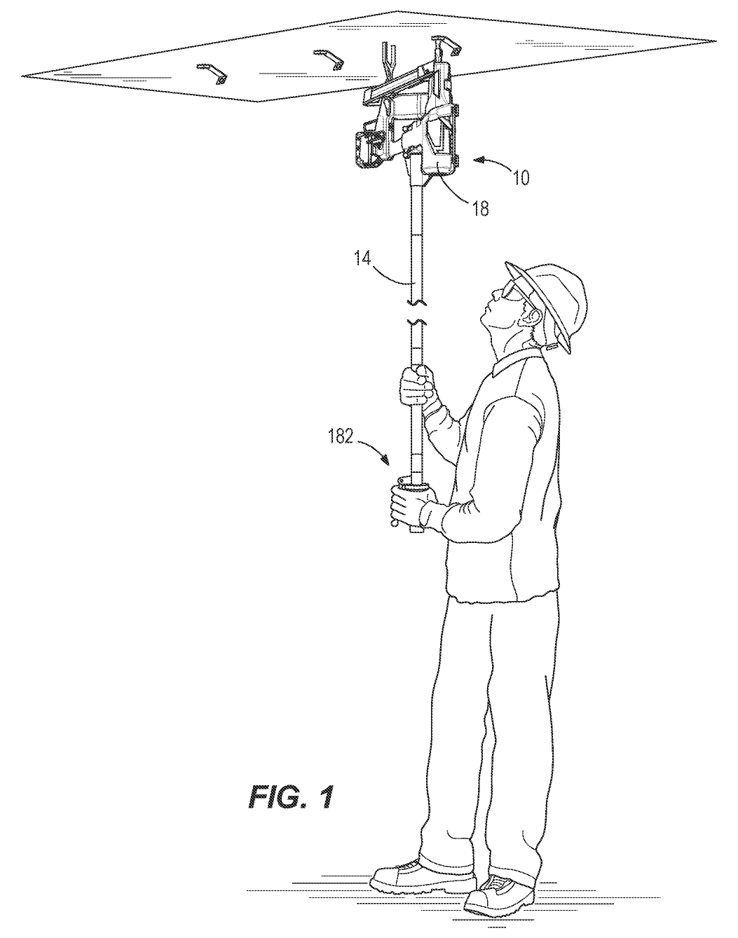

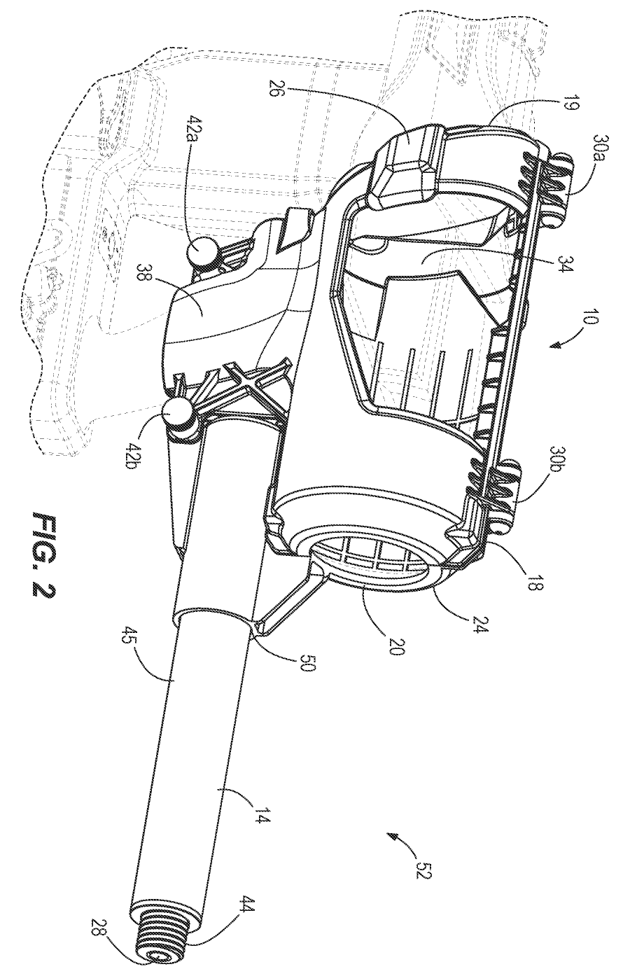

With reference to FIGS. 1, 2, 3, and 13, an extension pole assembly 10 for use with a power tool (e.g., a powered fastener driver like a concrete nailer) includes a mount 18, an extension pole 14, a handle 182, and an actuator linkage 52. The mount 18 includes a first mount portion 24 and a mating second mount portion 26. The second mount portion 26 pivots relative to the first mount portion 24 about hinges 30a, 30b to at least partially enclose the power tool between the first mount portion 24 and the second mount portion 26 within a power tool accommodation recess 34 (i.e., within the mount 18). The mount 18 includes a front side 18 and an opposite rear side 20. In some embodiments, the mount 18 may be made, partly or completely, from a carbon fiber material to reduce weight yet maintain a high tensile strength.

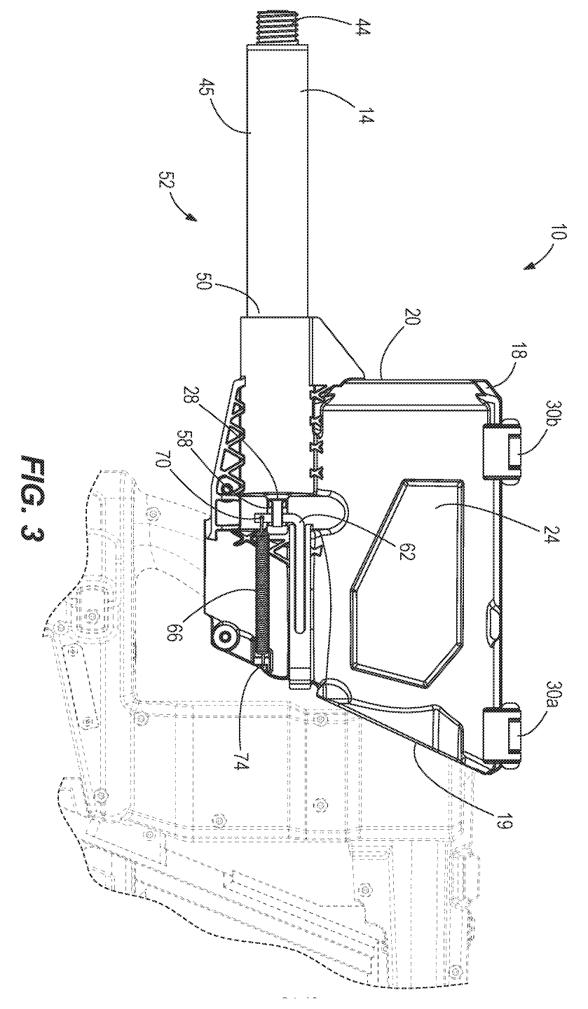

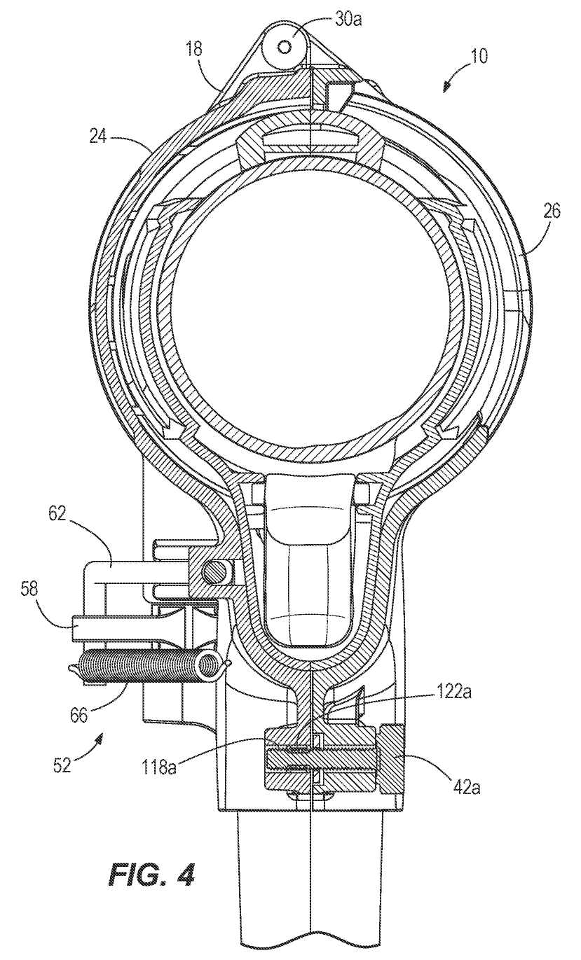

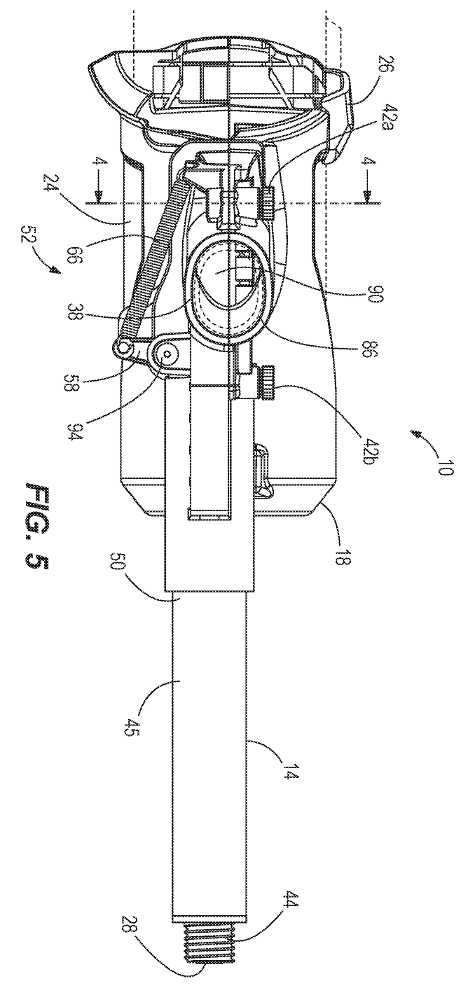

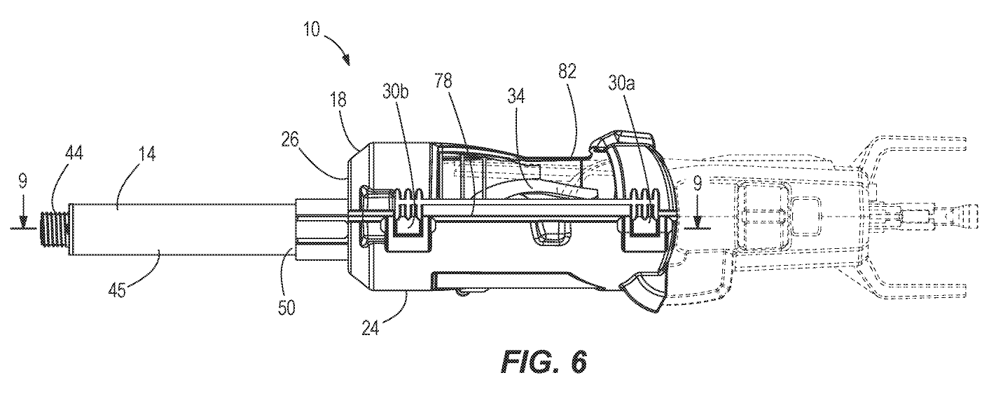

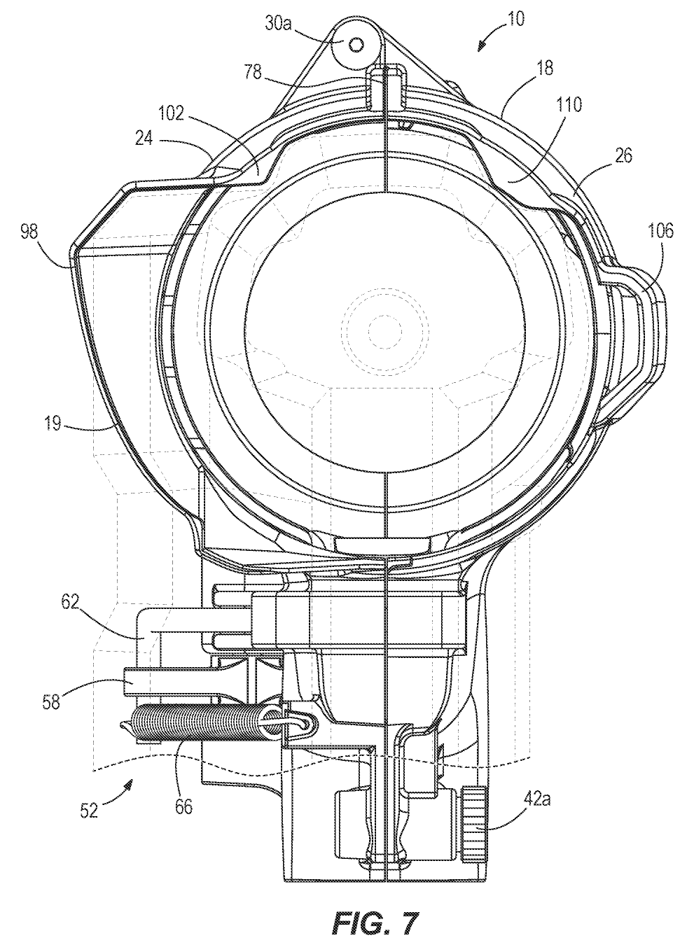

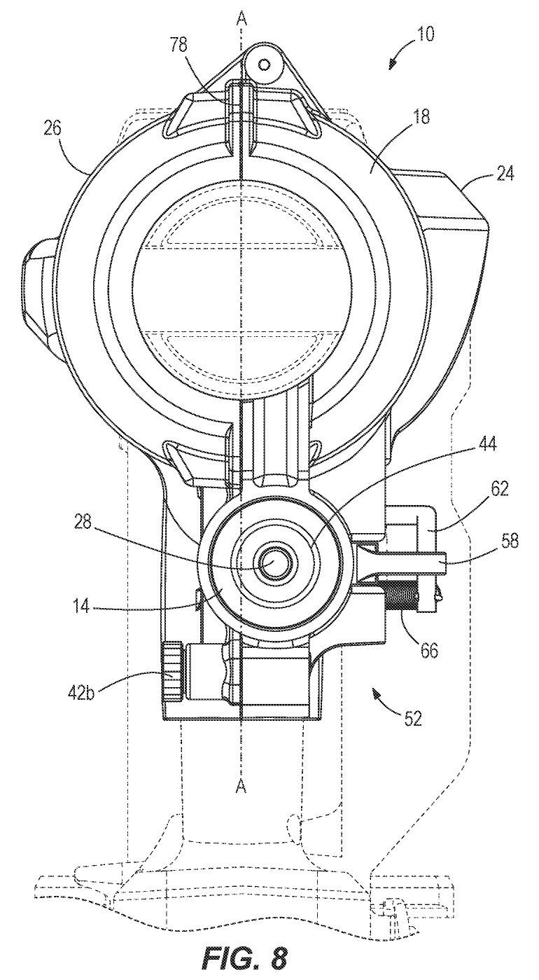

With reference to FIGS. 2 and 4, thumb screws 42a, 42b selectively fasten the first mount portion 24 to the second mount portion 26, thereby securing the power tool within the mount 18. A through-hole I 18a extends through both the first mount portion 24 and the second mount portion 26 to accommodate the thumb screw 42a (FIG. 4). A threaded insert 122a is positioned within the through-hole 118a to provide female threads to mate with male threads on the thumb screw 42a. An analogous through-hole and insert are provided to accommodate the thumb screw 42b.

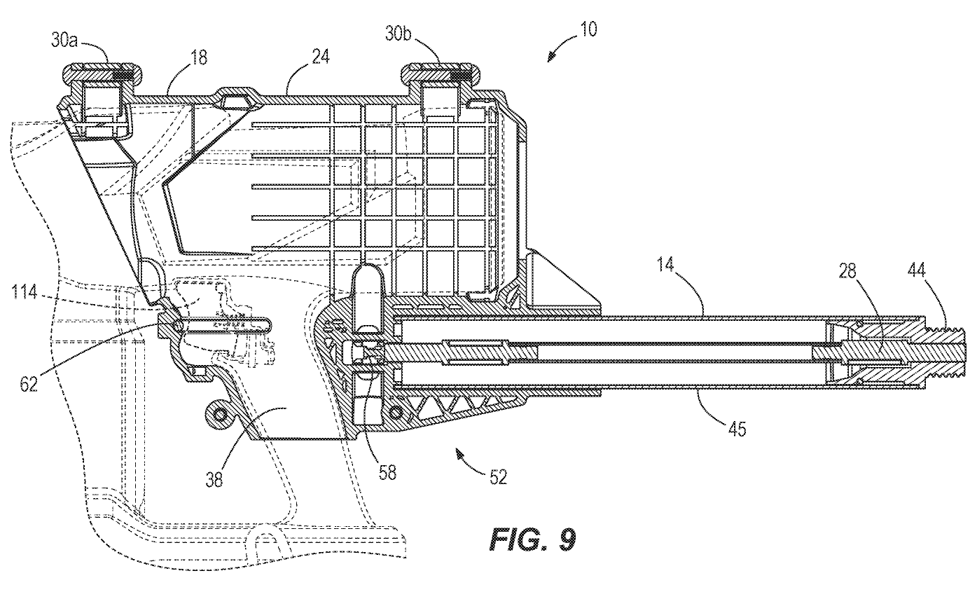

With reference to FIG. 5, a grip accommodating portion 38 of the mount 18 receives a grip or handle of the power tool when the power tool is received within the mount 18. The grip accommodating portion 38 includes an open bottom end 86 defining an aperture 90 through which the bottom end of the power tool grip extends.

With reference to FIG. 6, the second mount portion 26 pivots about the hinges 30a, 30b relative to the first mount portion 24 between an open position and a closed position (shown in FIGS. 4 and 6). In the closed position, the second mount portion 26 mates with the first mount portion 24 along a seam 78. The second mount portion 26 includes a viewing window 82 to provide visual and/or physical access to the power tool when the power tool is accommodated within the mount 18. The viewing window 82 may also provide the power tool with access to a cooling airflow.

With reference to FIG. 7, the first mount portion 24 includes a large first flare 98 and an adjacent first inward lip 102 at the front side 19 of the mount 18. The second mount portion 26 includes a small second flare 106 and an adjacent second inward lip 110 at the front side 19 of the mount 18. The first flare 98, the first inward lip 102, the second flare 106, and the second inward lip 110 may be sized and shaped to accommodate the power tool, to retain the power tool within the mount 18, and to provide the power tool with access to cooling airflow while the power tool is retained within the mount 18.

With reference to FIGS. 2 and 13, the extension pole 14 includes a first extension pole end 46 (FIG. 13) and an opposite second extension pole end 50 (FIG. 2). The extension pole 14 defines a longitudinal axis B (FIG. 13). The extension pole 14 may be a multi-piece extension pole 14 having interconnected segments including a first segment 43 (which includes the first extension pole end 46; shown in FIG. 13) and a second segment 45 (which includes the second extension pole end 50; shown in FIG. 2) that attaches to the first segment 43. The extension pole 14 may include additional intermediate segments according to a desired length of the extension pole 14. In the illustrated embodiment, the first segment 43 includes a first fastener portion 202 (e.g., a female thread segment 202) that attaches to the second segment 45 at a second fastener portion 44 (e.g., a male thread segment 44). The mount 18 is attached to the extension pole 14 at the second extension pole end 50 of the extension pole 14.

With continued reference to FIG. 13, the handle 182 includes a first handle end 183 that is connected to the first extension pole end 46 of the extension pole 14 and includes an opposite second handle end 184. The handle 182 includes a grip portion 186 between the first handle end 183 and the second handle end 184. The grip portion 186 is cylindrical and grasped by a user of the power tool. In some embodiments, the handle 182 includes a damper 210 (e.g., a cylindrical or annular foam piece) positioned at the first handle end 183. And, in some embodiments, the handle 182 includes a shock absorber 214, which may be made of rubber, at the second handle end 184 (i.e., at the end of the handle 182 opposite the mount 18).

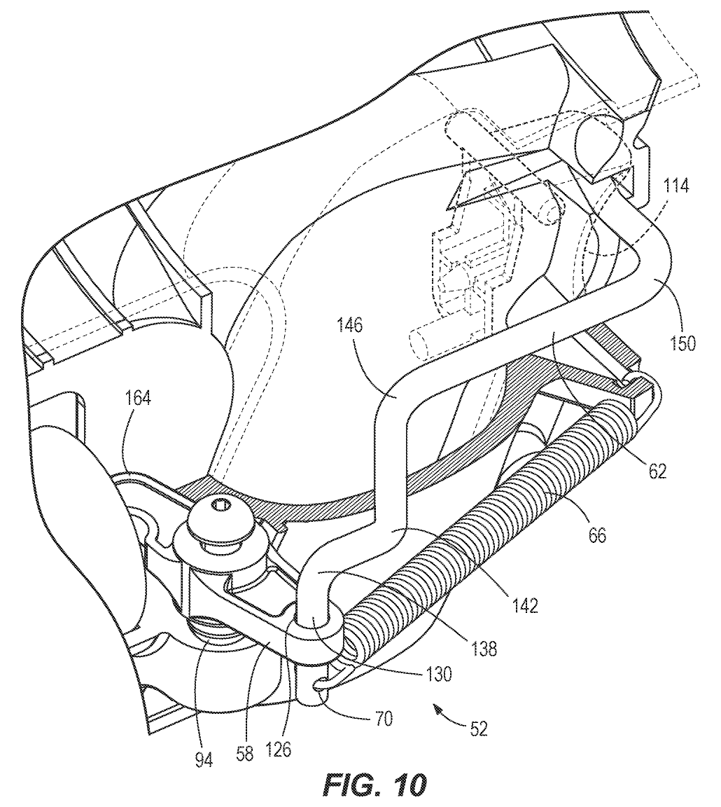

With reference to FIGS. 2, 9, 10, and 13, the actuator linkage 52 extends between the handle 182 and the mount 18. The actuator linkage 52 includes a shaft 28, a first lever 58, a hook 62, a biasing member 66 (e.g., a tension spring), and a second lever 190. The shaft 28 extends through the extension pole 14 from the first extension pole end 46 to the second extension pole end 50. In some embodiments, the shaft 28 may include a plurality of interconnected segments. For example, in embodiments in which the extension pole 14 includes multiple interconnected segments such as the first segment 43 and the second segment 45, the shaft 28 may include multiple interconnected segments corresponding to the segments 43, 45 of the extension pole 14. The shaft 28 is movable relative to the extension pole 14 along an actuation direction 170 (FIG. 12). Depending on a position of the shaft 28, it is possible for the first lever 58, the hook 62, and the spring 66 to be positioned in an unactuated position (shown in FIGS. 10-12), in a fully actuated position, or in a position therebetween. In the fully actuated position, the shaft 28 is maximally extended toward a front side 19 (FIG. 3) of the mount 18, and the hook 62 is moved away from the front side 19 of the mount 18 and toward a rear side 20 (FIG. 3) of the mount 18. The shaft 28, the first lever 58, and the hook 62 are positionable in a variety of positions between the unactuated position and the fully actuated position. In the illustrated embodiment, the shaft 28, the first lever 58, and the hook 62 are continuously adjustable between the unactuated position and the fully actuated position. With reference to FIG. 8, the seam 78 of the mount 18 defines a plane A. The shaft 28 is offset to one side of the plane A. More specifically, the shaft 28 is offset to the same side of the plane A as the first lever 58, to the same side of the plane A as the hook 62, and to the same side of the plane A as the spring 66. The shaft 28 is offset to the same side of the plane A as the first mount portion 24.

With reference to FIGS. 10-12, the shaft 28 directly (or, in some embodiments, indirectly) abuts the first lever 58 such that motion (e.g., linear motion) of the shaft 28 is transmitted into motion (e.g., pivotal motion) of the first lever 58. The first lever 58 is pivotably attached to the mount 18 and includes a first end 164 having an abutment protrusion 166 in sliding contact with the distal end of the shaft 28 and an opposite second end 165 pivotably coupled to the hook 62 via a through hole 126. A pin 94 (e.g., a fastener such as a bolt, a rivet, etc.) serves as a pivot point for the first lever 58. The first lever 58 includes a concave curvature 178 positioned between the pin 94 and the first end 164. The concave curvature 178 may at least partially define the abutment protrusion 166.

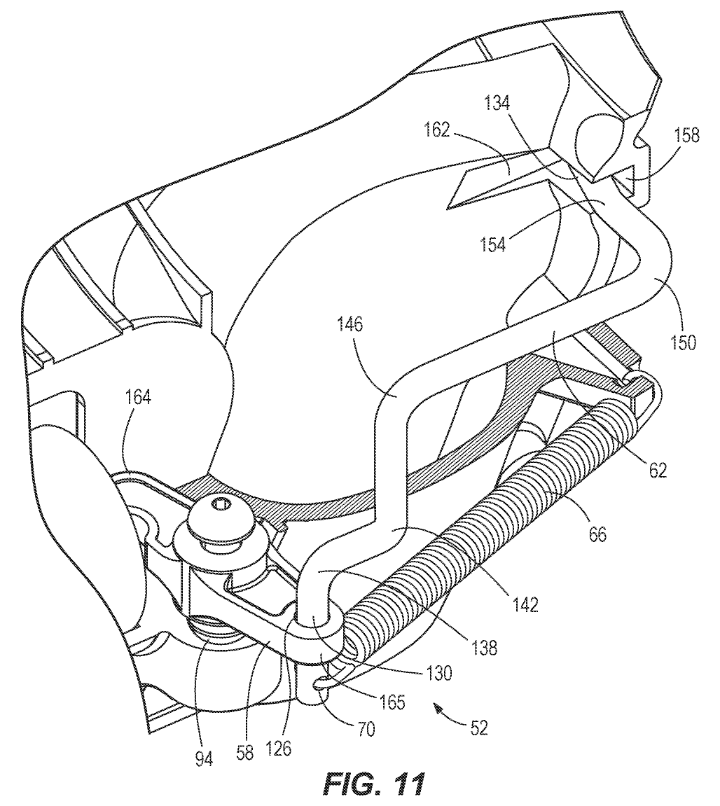

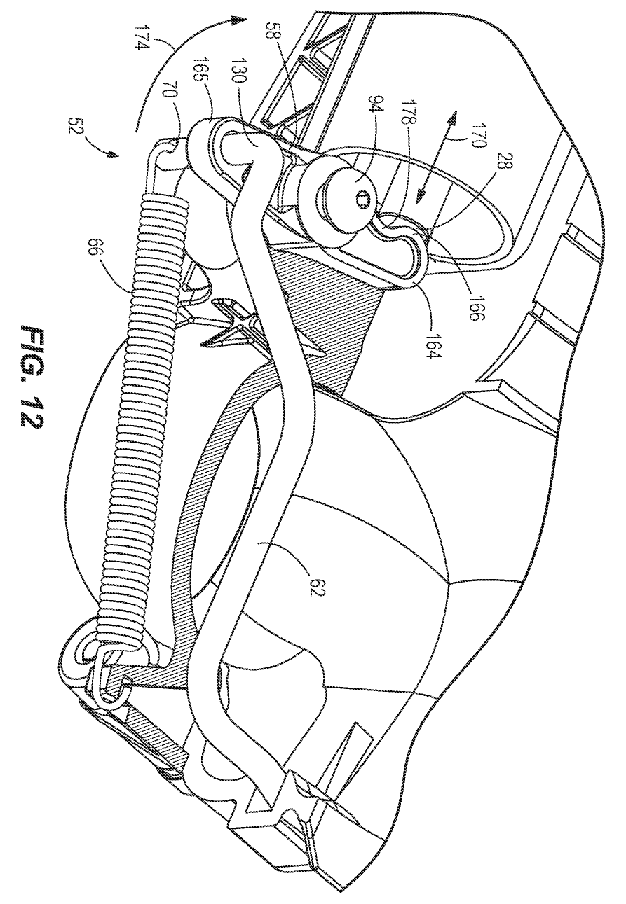

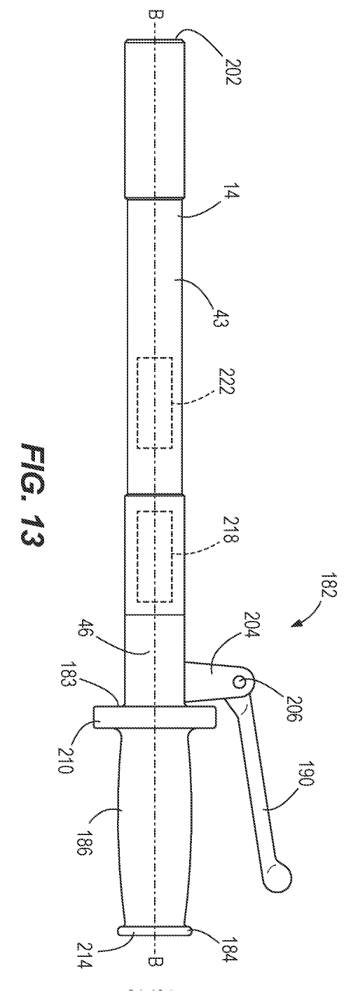

With continued reference to FIGS. 10-12, the hook 62 is attached to the first lever 58 such that pivotal motion of the first lever 58 is transmitted to the hook 62 in the form of motion of the hook 62 in a direction generally parallel to the actuation direction 170 of the shaft 28. With reference to FIG. 10, a trigger 114 of the power tool is illustrated within the mount 18 to show a general position of the trigger 114 relative to the other components of the extension pole assembly 10. The hook 62 extends between a first end 134 (FIG. 11), which is proximate the trigger 114 to engage and depress the trigger 114, an opposite second end 130. Moving away from the first end 134 and toward the second end 130, the hook 62 includes a first bend 154, a second bend 150, a third bend 146, a fourth bend 142, and a fifth bend 138 (FIG. 11). With reference to FIG. 11, the mount 18, and more specifically in some embodiments the second mount portion 26, includes a first notch 158 in which the first end 134 of the hook 62 is received when in the unactuated position and a second notch 162 transverse to the first notch 158. The first end 134 of the hook 62 slides in a first direction (i.e., toward the rear side 20 of the mount 18 shown in FIG. 3) within the second notch 162 as the actuator linkage 52 is moved from the unactuated position toward the fully actuated position and slides in a second direction (i.e., toward the front side 19 of the mount 18 shown in FIG. 3) when the actuator linkage 52 is moved toward the unactuated position.

With reference to FIGS. 10-12, the spring 66 biases the abutment protrusion 166 of the first lever 58 into contact with the shaft 28 such that motion of the shaft 28 in the actuation direction 170 toward the front side 19 of the mount 18 pivots the first lever 58 in a rotational direction 174. The spring 66 extends between a first attachment location 70 and a second attachment location 74 (FIG. 3). The first attachment location 70 is provided on the hook 62, and the second attachment location 74 is provided on the mount 18 and more specifically, in the illustrated embodiment, on the first mount portion 24 (FIG. 3). The spring 66 biases the hook 62 into the unactuated position and provides controlled resistance against moving the hook 62 from the unactuated position toward the fully actuated position. The spring 66 also biases the hook 62 toward the unactuated position in the absence of actuation by the user.

With reference to FIG. 13, the second lever 190 is positioned adjacent the handle 182 and extends generally parallel to or, in some embodiments, at an angle relative to the grip portion 186. The second lever 190 is mounted to a bracket 204 and pivots about a pivot axis 206 upon actuation by a user. Motion of the second lever 190 about the pivot axis 206 results in linear motion of the shaft 28 along the actuation direction 170 as described above, which causes selective actuation of the trigger 114 of the power tool (FIG. 10).

With continued reference to FIG. 13, in some embodiments, the extension pole assembly 10 may include a wireless communication protocol 218 (e.g., BLUETOOTH) to remotely operate the power tool instead of the actuator linkage 52 or in addition to the actuator linkage 52. In some embodiments, a battery pack 222 that powers the power tool is mounted to the extension pole 14 and/or the handle 182. Electric current from the battery pack 222 is transmitted to the power tool via the extension pole 14.

In operation, and with reference to FIGS. 2, 10, and 13, a user may squeeze the second lever 190 toward the grip portion 186 to translate the shaft 28 forward (i.e., toward the mount 18), thereby pivoting the first lever 58 in the clockwise rotational direction 174 shown in FIG. 12. With the hook 62 pivotably attached to the second end 165 of the first lever 58, the hook 62 is translated rearward (i.e., toward the extension pole 14), thereby tensioning the spring 66, and depressing the trigger 114 to activate the power tool. In other words, the second lever 190 is pivotable between a non-actuated (or "unactuated") position corresponding to the unactuated position of the first lever 58, and a fully actuated position corresponding to the fully actuated position of the first lever 58. When the user releases the second lever 190, the tension spring 66 rebounds, thereby pivoting the first lever 58 back to the non-actuated position shown in FIGS. 10, 11, and 13 and translating the hook 62 in the forward direction to release the power tool trigger 114, which deactivates the power tool.

In some embodiments, the second lever 190 and the bracket 204 can selectively rotate about the longitudinal axis B of the extension pole 14 and first segment 43 to allow a user to adjust an orientation of the mount 18, and therefore to adjust an orientation of the power tool accommodated within the mount 18, relative to the user's hand without adjusting an orientation of the mount 18 or the power tool relative to the extension pole 14. The damper 210 attenuates vibration and/or impacts from the power tool, thereby lessening vibration and/or impacts felt by a user's hand when holding the grip portion 186. The shock absorber 214 may absorb shock if the extension pole assembly 10 is dropped.

Although the invention has been described in detail with reference to certain preferred embodiments, variations and modifications exist within the scope and spirit of one or more independent aspects of the invention as described.

What is claimed is:

1. An extension pole assembly for a power tool, the extension pole assembly comprising:
a mount including a first mount portion and a second mount portion, the second mount portion configured to pivot relative to the first mount portion to at least partially enclose the power tool within the mount;
an extension pole having a first extension pole end and an opposite, second extension pole end coupled to the mount;
a handle coupled to the first extension pole end, the handle to be grasped by a user of the power tool; and
an actuator linkage extending between the first extension pole end and the second extension pole end, the actuator linkage including:
a shaft extending between the first extension pole end and the second extension pole end,
a hook supported by the mount and having a first portion configured to engage a trigger of the power tool when supported within the mount, and
a lever pivotably coupled to the mount and having a first lever end abutted with the shaft and a second lever end coupled to a second portion of the hook;
wherein, in response to movement of the shaft within the extension pole, the lever is pivotable from a first position towards a second position, in which the first portion of the hook depresses the trigger of the power tool.

2. The extension pole assembly of claim 1, further comprising a spring biasing the lever toward the first position.

3. The extension pole assembly of claim 1, wherein the lever is a first lever, wherein the actuator linkage further includes a second lever adjacent the handle and coupled to the shaft, and wherein the second lever is pivotable between a non-actuated position corresponding to the first position of the first lever, and an actuated position corresponding to the second position of the first lever.

4. The extension pole assembly of claim 3, wherein an orientation of the second lever on the extension pole is adjustable about a longitudinal axis of the extension pole to adjust an orientation of the mount relative to a user's hand without adjusting an orientation of the mount relative to the extension pole.

5. The extension pole assembly of claim 1, further comprising a wireless communication protocol configured to remotely control the power tool.

6. The extension pole assembly of claim 1, further comprising a battery pack mounted to the extension pole, wherein electric current from the battery pack powers the power tool.

7. The extension pole assembly of claim 1, further comprising a battery pack mounted to the handle, wherein electric current from the battery pack powers the power tool.

8. The extension pole assembly of claim 1, wherein the handle includes a cylindrical foam damper adjacent to a grip portion of the handle, wherein the damper is configured to attenuate vibration transmitted from the power tool toward a user grasping the grip portion.

9. The extension pole assembly of claim 1, wherein the handle includes a rubber shock absorber at an end of the handle opposite the mount.

10. A powered fastener driver assembly comprising:
a powered fastener driver including a housing having a driver portion in which a reciprocating drive blade is movable and a handle portion extending from the driver portion, and an extension pole assembly including:
a mount including a first mount portion and a second mount portion, the second mount portion configured to pivot relative to the first mount portion to at least partially enclose the powered fastener driver within the mount,
an extension pole having a first extension pole end and an opposite, second extension pole end coupled to the mount,
a handle coupled to the first extension pole end, the handle to be grasped by a user of the powered fastener driver, and
an actuator linkage extending between the first extension pole end and the second extension pole end, the actuator linkage including:
a shaft extending between the first extension pole end and the second extension pole end,
a hook supported by the mount and having a first portion configured to engage a trigger of the powered fastener driver when supported within the mount, and
a lever pivotably coupled to the mount and having a first lever end abutted with the shaft and a second lever end coupled to a second portion of the hook,
wherein, in response to movement of the shaft within the extension pole, the lever is pivotable from a first position towards a second position, in which the first portion of the hook depresses the trigger of the powered fastener driver, wherein the mount at least partially encloses the driver portion of the housing.

11. The powered fastener driver assembly of claim 10, wherein the lever is a first lever, wherein the actuator linkage further includes a second lever adjacent the handle and coupled to the shaft, and wherein the second lever is pivotable between a non-actuated position corresponding to the first position of the first lever, and an actuated position corresponding to the second position of the first lever.

12. The powered fastener driver assembly of claim 10, further comprising a wireless communication protocol configured to remotely control the powered fastener driver.

13. The powered fastener driver assembly of claim 10, further comprising a battery pack mounted to the handle, wherein electric current from the battery pack powers the powered fastener driver.

14. The powered fastener driver assembly of claim 10, further comprising a spring biasing the lever toward the first position.

15. An extension pole assembly for a power tool, the extension pole assembly comprising:
a carbon fiber mount including a first mount portion and a second mount portion, the second mount portion configured to pivot relative to the first mount portion to at least partially enclose the power tool within the mount;
an extension pole having a first extension pole end and an opposite, second extension pole end coupled to the mount; a handle coupled to the first extension pole end, the handle to be grasped by a user of the power tool; and
an actuator linkage extending between the first extension pole end and the second extension pole end, the actuator linkage including a lever pivotably coupled to the mount, the lever being pivotable from a first position towards a second position to actuate the power tool.

16. The extension pole assembly of claim 15, further comprising a spring biasing the lever toward the first position.

17. The extension pole assembly of claim 15, wherein the lever is a first lever, wherein the actuatorlinkage further includes a second lever adjacent the handle, andwherein the second lever ispivotable between a non-actuated positioncorresponding to the first position of the first lever, and an actuated positioncorresponding to the second position of the first lever.

18. The extension pole assembly of claim 17, wherein an orientation of the second lever on the extension pole is adjustable about a longitudinal axis of the extension pole to adjust an orientation of the mount relative to a user's hand without adjusting an orientation of the mount relative to the extension pole.

19. The extension pole assembly of claim 18, further comprising a battery pack mounted to the extension pole, wherein electric current from the battery pack powers the power tool.

20. The extension pole assembly of claim 18,wherein the handle includes a rubber shock absorber at an end of the handle opposite the mount.
